(19) United States
(12) Patent Application Publication
(10) Pub. No.: US 2026/0234971 A1
(43) Pub. Date: Aug. 13, 2026

(54) ROBOTIC DOOR LATCH UNLATCHING MECHANISM AND METHOD THEREOF

(71) Applicant: Prehensile Technologies, LLC, West Lafayette, IN (US)

(72) Inventors: JEFFREY ACKERMAN, Arvada, CO (US); BRADLEY DUERSTOCK, West Lafayette, IN (US); Severn Swift, SAN FRANCISCO, CA (US); NATHAN JOHNSON, West Lafayette, IN (US); PHILLIP BELL, Battleground,, IN (US)

(73) Assignee: Prehensile Technologies, LLC, West Lafayette, IN (US)

(21) Appl. No.: 19/536,192

(22) Filed: Feb. 10, 2026

Related U.S. Application Data
(60) Provisional application No. 63/756,585, filed on Feb. 10, 2025.

(51) Int. Cl. E05B 85/12; E05B 15/02; E05B 47/00; E05B 77/34; E05B 85/16

(52) U.S. Cl. CPC E05B 85/12; E05B 15/0205; E05B 47/0012; E05B 77/34; E05B 85/16

(57) ABSTRACT

A door unlatching apparatus and system for automating the retraction of spring-loaded latches commonly found in residential and commercial door knob assemblies. The apparatus includes a base plate mountable to a door or door frame, an unlatching plate having an aperture to receive the latch, a motor assembly, and a linkage assembly configured to translate motor rotation into linear movement of the unlatching plate. The unlatching plate moves from a first position to a second position, engaging a sloped portion of the latch to depress it and covering the base plate aperture to prevent re-engagement with a strike plate, thereby permitting the door to open freely. The apparatus may include electronic control circuitry, wireless communication capability, integration with smart lock systems, proximity sensors, user interface elements, and a latch popper assembly for physically moving the door to an ajar position.

### CROSS-REFERENCE TO RELATED APPLICATION

This application claims priority to U.S. Provisional Patent Application No. 63/756,585 filed February 10, 2025 and is herein incorporated by reference in its entirety.

### FIELD OF THE INVENTION

This invention relates generally to a method, apparatus, and system to unlock a door latch for easier use of operation and automation of opening hinged or sliding door. More particularly, the invention relates to a mechatronic device configured to unlatch door latches and that can be retrofitted to existing doors.

### BACKGROUND

Existing automatic door opener solutions all look similar. These systems attach to the top of a door and an adjacent wall or door frame to open and close a door. They are essential to provide independent access through doors for people with disabilities that are unable to reliably open a door by themselves. Automatic doors are required for many public door entrances by the Americans with Disabilities Act (ADA), but these regulations don’t apply to a user’s home. Existing automatic door opener solutions can be installed professionally for an estimated $2-4k (including labor – estimate is based on Google search results). This installation cost is prohibitive for most people with disabilities, so most users will choose to automate the minimum number of doors in their home (typically one door). This necessary decision makes a user’s home significantly less accessible to them daily. It can also be unsafe in the case of an emergency when quick mobility and egress is required, such as during a fire.

Fully automatic door opening systems are very expensive and complex to install, which makes them less accessible to individuals or commercial buildings and facilities. A new unlatching system that is easier and cheaper to install could substantially reduce the installation cost of automatic door openers, or, if installed by itself, could provide a simpler, more targeted solution to enhance door accessibility. A common motorized solution for automatic doors to unlatch a spring-loaded latch is the electronic strike plate. The electronic strike plate is a device with metal plates that hold the latch in place like a conventional strike plate in a door frame while the door is closed. These devices require extensive physical modifications to the door frame to install the electronic strike plate, such as using a jigsaw, multitool, saw, or Dremel to make a sufficiently large cutout in the door frame that requires skilled manual labor. The wiring of these mechanisms can also be difficult because they are wired, and the wire needs to be routed back to the automatic door opener.

In addition, typical spring-loaded door latches prevent automatic doors from working because the latch blocks the opening motion of the door when it’s closed. Therefore, these conventional automatic door opener installations need to install their own electrically controlled latches in the door frame or doorknobs in the door to engage a latch when the door should stay closed and disengage the latch when the automatic door is opened. Most automatic doors require the electrically controlled latch to be installed with the door, which requires a separate electrical connection running through or outside the door frame. Other options include removing or physically blocking the spring-loaded latch, but the spring-loaded latch is useful to keep the door closed, particularly for exterior doors that can open unintentionally due to forces from wind, pressure differences, or an imbalanced door weight.

It is very difficult for someone with no or limited strength, dexterity, or range of motion in their hands and arms to synchronously turn a door handle to unlatch and pull or push open doors. There exists a need for a robotic device that can be easily adapted to pre-existing doors to enable the user to independently unlatch a door to allow the door to be opened manually or with a separate automatic door opener.

### BRIEF SUMMARY OF THE INVENTION

In one aspect, this disclosure is related to door unlatching apparatus having an unlatching plate configured to interface against a base plate of a door or door frame. The unlatching plate has a first aperture configured to approximate a shape of a spring-loaded latch of a door knob. A linkage assembly can have a first end and a second end, wherein the first end is configured to couple to a portion of the unlatching plate. A motor assembly configured to couple to a surface of the door, wherein the motor assembly is coupled to a second end of the linkage assembly, wherein the motor can move the unlatching plate between a first position and a second portion. The apparatus can push on the sloped portion of the spring-loaded latch to push it out of a strike plate receptacle when moved from the first position to the second position to push the latch back and block it from springing back into the strike plate receptable and allow the door to be easily pushed, pulled, or moved from a closed position to an open position.

In another aspect, the present disclosure relates to a door unlatching apparatus designed to remotely or automatically retract a spring-loaded latch of a door knob assembly. The apparatus comprises a base plate configured to couple to a door or door frame, which may be mounted directly onto existing hardware using the existing screws typically used to secure a door's latch plate or a door frame's strike plate. An unlatching plate can be configured to interface against a base plate of the door or door frame and includes a first aperture configured to approximate the shape of the spring-loaded latch. A linkage assembly having a first end and a second end connects the unlatching plate to a motor assembly, wherein the linkage assembly includes one or more arms can translate rotational motion from the motor to move the unlatching plate between a first position that allows the latch to spring into the latch receptacle and a second position where the latch is pushed back into the door. The apparatus can further include an electronic logic circuitry coupled with the motor assembly, linkage assembly, and unlatching plate to control the sequence of operations based on an input trigger. A controller may be programmed to process sensor data and control motor operation for precise and controlled movement of the unlatching plate. The apparatus may include a user interface comprising buttons for manual actuation, LEDs for visual feedback indicating the status of the unlatching process, and an auditory feedback system for emitting tones to confirm actions or indicate malfunctions. Various power sources may be employed, including direct wired connections to a house outlet or circuit, battery-powered units, automatic door opener system units, or solar-powered units. The apparatus may include a transceiver configured to communicate with external devices through a wireless network, as well as input ports enabling communication with automatic door opener systems or automatic deadbolts for smart door system integration. Additional features may include a smart lock or deadbolt system communicatively coupled to the controller to confirm whether the door is unlocked before initiating the unlatching process, a proximity sensor for automatically triggering the unlatching process when a person approaches, and a touch sensor enabling users to activate the mechanism by touching a designated area. The apparatus may further comprise a latch popper assembly mounted to the door, latch plate, or adjacent wall, having an extendable length and a grip member configured to exert controlled force against the door frame or adjacent wall.

In another aspect, the present disclosure provides a door unlatching apparatus that includes a base plate configured to be mounted to an edge surface of a door. The base plate has a first aperture configured to receive a spring-loaded latch of a door knob therethrough. An unlatching plate is positioned over at least a portion of the base plate, with the unlatching plate having a second aperture configured to align with the first aperture to permit the spring-loaded latch to extend therethrough when the unlatching plate is in a first position. A motor assembly is coupled to the base plate, and a linkage assembly has a first end operatively coupled to the motor assembly and a second end coupled to the unlatching plate. The linkage assembly is configured to translate motion from the motor assembly to move the unlatching plate from the first position to a second position. When the unlatching plate is moved to the second position, the unlatching plate engages a sloped portion of the spring-loaded latch to depress the latch and covers the first aperture to prevent the latch from re-engaging a strike plate, thereby permitting the door to be opened.

In another aspect, the present disclosure provides a door unlatching apparatus configured for mounting to a door frame rather than to the door itself. The apparatus includes a base plate configured to be mounted to the door frame, with the base plate having a first aperture configured to receive a spring-loaded latch of a door knob therethrough. An unlatching plate is positioned relative to the base plate, with the unlatching plate having a second aperture configured to align with the first aperture to permit the spring-loaded latch to extend therethrough when the unlatching plate is in a first position. A motor assembly is coupled to the door frame or the base plate, and a linkage assembly has a first end operatively coupled to the motor assembly and a second end coupled to the unlatching plate. The linkage assembly is configured to move the unlatching plate from the first position to a second position. When the unlatching plate is moved to the second position, the unlatching plate expels the spring-loaded latch from within the first aperture and covers the first aperture to prevent the latch from re-engaging, thereby permitting the door to be opened.

In yet another aspect, the present disclosure provides a depth-adjustable strike plate for use with a door unlatching system. The depth-adjustable strike plate includes a strike plate body having a first surface and an aperture configured to receive a spring-loaded latch of a door knob. A back wall is positioned within the aperture, and a depth adjustment member is coupled to the back wall and configured to adjust a depth that the spring-loaded latch can extend into the strike plate. The depth adjustment member reduces the depth of the aperture to position an angular portion of the spring-loaded latch for engagement by an unlatching plate of a door unlatching apparatus.

In a further aspect, the present disclosure provides a door unlatching apparatus that includes a latch popper assembly. The apparatus includes a base plate configured to be mounted to a door, and an unlatching plate configured to interface against the base plate. The unlatching plate has an aperture configured to receive a spring-loaded latch therethrough in a first position. A first motor assembly is coupled to the base plate and configured to move the unlatching plate from the first position to a second position to depress and cover the spring-loaded latch. A latch popper assembly is mounted to the door and includes an actuator-driven arm having an extendable length and configured to extend from a first position to at least a second position, and a grip member pivotably coupled to an end of the actuator-driven arm and configured to interface with a surface of a door frame or adjacent wall. The latch popper assembly is configured to exert a controlled force against the door frame or adjacent wall to move the door from a closed position to an ajar or open position after the unlatching plate has depressed the spring-loaded latch.

In still another aspect, the present disclosure provides a modified strike plate for use with a door unlatching apparatus and a door having a deadlatch. The modified strike plate includes a strike plate body having a surface and an aperture configured to receive a spring-loaded latch of a door knob. A relief or cutout geometry is positioned on the strike plate body to coincide with a deadlatch bolt of the door. The relief or cutout geometry provides a void that prevents the deadlatch bolt from being depressed against the strike plate surface, thereby maintaining the deadlatch in a disengaged state and permitting the spring-loaded latch to be retracted by an unlatching plate of a door unlatching apparatus.

In another aspect, the present disclosure provides a smart door system that includes a door unlatching apparatus having a base plate configured to be mounted to a door or door frame, an unlatching plate having an aperture configured to receive a spring-loaded latch therethrough in a first position, a motor assembly configured to move the unlatching plate from the first position to a second position to depress and cover the spring-loaded latch, and a controller communicatively coupled to the motor assembly. The system can optionally include a smart deadbolt communicatively coupled to the controller, wherein the controller is configured to determine a state of the smart deadbolt. The controller is configured to initiate an unlatching sequence only upon confirmation that the smart deadbolt is in an unlocked state.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A is a perspective view of an exemplary embodiment of a door unlatching apparatus of the present disclosure in a first position.

FIG. 1B is a perspective view of an exemplary embodiment of a door unlatching apparatus of the present disclosure in a second position.

FIG. 2A is a side view of an exemplary embodiment of a door unlatching apparatus of the present disclosure in a first position.

FIG. 2B is a side view of an exemplary embodiment of a door unlatching apparatus of the present disclosure in a second position.

FIG. 3 is a front view of an exemplary embodiment of a door unlatching apparatus of the present disclosure.

FIG. 4 is a side view of an exemplary embodiment of a door unlatching apparatus of the present disclosure in a first position having guide rails.

FIG. 5 is a perspective view of an exemplary embodiment of a door unlatching apparatus of the present disclosure in a first position having guide rails.

FIG. 6A is an illustration of a traditional latch strike plate with a standard depth recess.

FIG. 6B is an illustration of a latch strike plate depth adjustment element of the present disclosure.

FIG. 7 is a diagram of an exemplary method of an unlatching system comprising an apparatus of the present disclosure.

FIG. 8A is a system diagram of an exemplary embodiment of a door unlatching apparatus and system of the present disclosure with various features.

FIG. 8B is a system diagram of an exemplary embodiment of a door unlatching apparatus of the present disclosure with various features.

FIG. 9 is a perspective view of an exemplary embodiment of an unlatching plate of the present disclosure.

FIG. 10A is a perspective view of an exemplary embodiment of a door unlatching apparatus of the present disclosure mounted to a door frame in a first position.

FIG. 10B is a perspective view of an exemplary embodiment of a door unlatching apparatus of the present disclosure mounted to a door frame in a second position.

FIG. 10C is a side view of an exemplary embodiment of a door unlatching apparatus of the present disclosure mounted to a door frame in a first position.

FIG. 10D is a side view of an exemplary embodiment of a door unlatching apparatus of the present disclosure mounted to a door frame in a second position.

FIG. 10E is a top view of an exemplary embodiment of a door unlatching apparatus of the present disclosure mounted to a door frame in a first position.

FIG. 10F is a top view of an exemplary embodiment of a door unlatching apparatus of the present disclosure mounted to a door frame in a second position.

FIG. 11A is a front view of an exemplary embodiment of a depth adjustable strike (screw type) or latch plate of a door unlatching apparatus of the present disclosure.

FIG. 11B is a side view of an exemplary embodiment of a depth adjustable strike (screw type) or latch plate of a door unlatching apparatus of the present disclosure in a retracted position.

FIG. 11C is a side view of an exemplary embodiment of a depth adjustable strike (screw type) or latch plate of a door unlatching apparatus of the present disclosure in an extended position.

FIG. 11D is a front view of an exemplary embodiment of a depth adjustable strike or latch plate of a door unlatching apparatus of the present disclosure.

FIG. 11E is a top view of an exemplary embodiment of a depth adjustable strike (low depth) or latch plate of a door unlatching apparatus of the present disclosure.

FIG. 11F is a side view of an exemplary embodiment of a depth adjustable strike (low depth) or latch plate of a door unlatching apparatus of the present disclosure.

FIG. 11G is a top view of an exemplary embodiment of a depth adjustable strike (high depth) or latch plate of a door unlatching apparatus of the present disclosure.

FIG. 11H is a side view of an exemplary embodiment of a depth adjustable strike (high depth) or latch plate of a door unlatching apparatus of the present disclosure.

FIG. 11I is a front view of an exemplary embodiment of a depth adjustable strike (hole block) or latch plate of a door unlatching apparatus of the present disclosure.

FIG. 11J is a side view of an exemplary embodiment of a depth adjustable strike (hole block high depth) or latch plate of a door unlatching apparatus of the present disclosure.

FIG. 11K is a side view of an exemplary embodiment of a depth adjustable strike (hole block low depth) or latch plate of a door unlatching apparatus of the present disclosure.

FIG. 12A is a front view of exemplary embodiments of a replaceable latching or strike plate of the present disclosure with a partial enclosure.

FIG. 12B is a side view of exemplary embodiments of a replaceable latching or strike plate of the present disclosure with a partial enclosure.

FIG. 13A is a front view of exemplary embodiments of a replaceable latching or strike plate of the present disclosure with a partial enclosure.

FIG. 13B is a side view of exemplary embodiments of a replaceable latching or strike plate of the present disclosure with a partial enclosure.

FIG. 14A is a front view of an exemplary embodiments of a replaceable unlatching plate of the present disclosure with a partial enclosure.

FIG. 14B is a perspective view of an exemplary embodiments of a replaceable unlatching plate of the present disclosure with a partial enclosure.

FIG. 15A is a front view of an exemplary embodiment of a door unlatching apparatus having a latch popper of the present disclosure.

FIG. 15B is a side view of an exemplary embodiment of a door unlatching apparatus having a latch popper, of the present disclosure.

FIG. 15C is a perspective view of an exemplary embodiment of a door unlatching apparatus having a latch popper of the present disclosure in a first position.

FIG. 15D is a perspective view of an exemplary embodiment of a door unlatching apparatus, having a latch popper of the present disclosure in a second position.

FIG. 15E is a perspective view of an exemplary embodiment of a door unlatching apparatus having a latch popper of the present disclosure in a third position.

FIG. 16A is a perspective view of an exemplary embodiment of a door unlatching apparatus having a latch popper of the present disclosure for an integrated mortise-lock system.

FIG. 16B is a side view of an exemplary embodiment of a door unlatching apparatus having a latch popper of the present disclosure for an integrated mortise-lock system.

FIG. 17A is a front view of an exemplary embodiment of a door unlatching apparatus, having a latch popper of the present disclosure for an integrated mortise-lock system.

FIG. 17B is a side view of an exemplary embodiment of a door unlatching apparatus having a latch popper of the present disclosure for an integrated mortise-lock system.

FIG. 18A is an illustration of an exemplary embodiment of a traditional deadlatch strike plate.

FIG. 18B is an illustration of an exemplary embodiment of a deadlatch strike plate of the present disclosure.

FIG. 18C is an illustration of a deadlatch strike plate of the present disclosure interfacing with a latch.

FIG. 19A is an illustration of an exemplary embodiment of a traditional commercial deadlatch strike plate.

FIG. 19B is an illustration of an exemplary embodiment of a commercial deadlatch strike plate of the present disclosure.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s), or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

As used herein, the terms “front,” “back,” “rear,” “upper,” “lower,” “right,” and “left” in this description are merely used to identify the various elements as they are oriented in the FIGS, with “front,” “back,” and “rear” being relative to the apparatus. These terms are not meant to limit the elements that they describe, as the various elements may be oriented differently in various applications.

As used herein, the term “coupled” means the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate members being attached to one another. Such joining may be permanent in nature or alternatively may be removable or releasable in nature. Similarly, coupled can refer to a two member or elements being communicatively coupled, wherein the two elements may be electronically, through various means, such as a metallic wire, wireless network, optical fiber, or other medium and methods.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element without departing from the teachings of the disclosure.

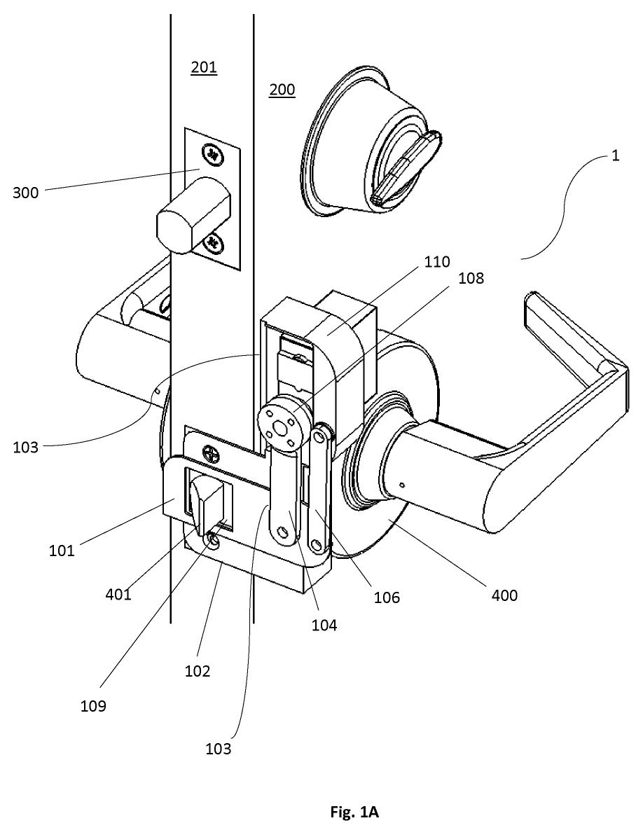

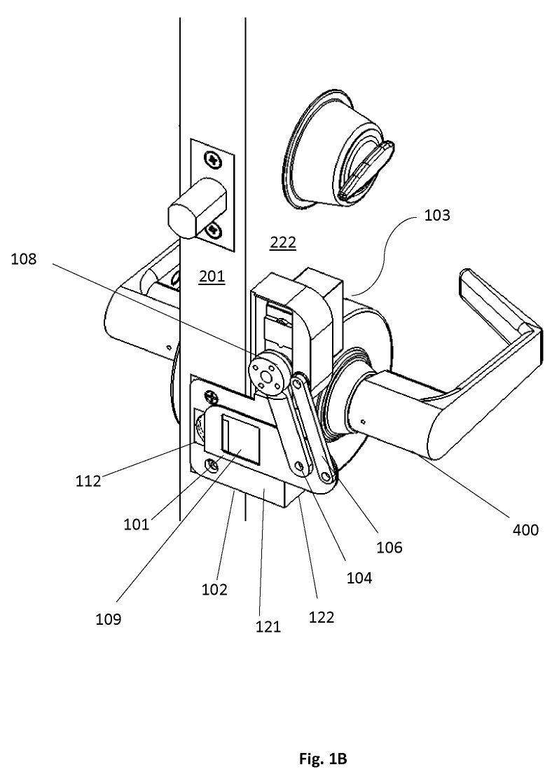

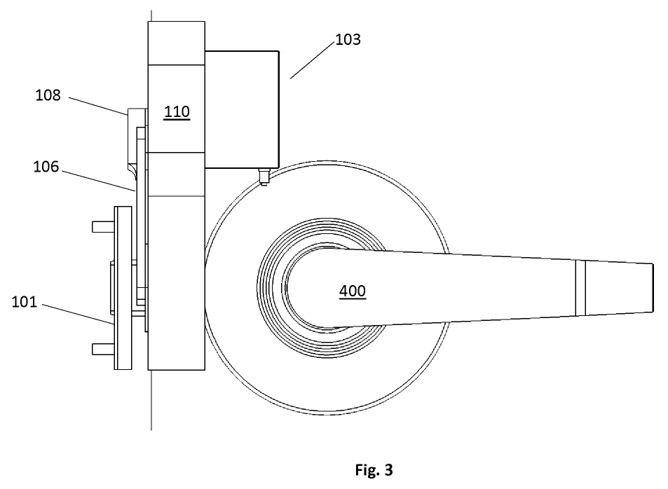

As shown in FIGS. 1-19, the present disclosure provides an unlatching door apparatus, system, and method to allow a user to easily adapt common doorknobs with spring loaded latches to be automated for opening using a switch, transceiver, or other device in communication with the unlatching door apparatus. The apparatus 1 reduces the installation complexity and cost of having automatic unlocking doors that improve their overall usability, accessibility, and adoption for users that may not be able to afford current latching mechanisms.

As shown in FIGS. 1-19, an apparatus and system 1 of the present disclosure can be mounted directly to a door 200. The apparatus 1 can an actuating or drive assembly 103 that can include a housing 110 to house a drive assembly 103 that can include any suitable means, such as but not limited to a motor or drive and actuator. The housing 110 can additionally house other electronic components including but not limited to a controller, transceiver, or simple circuit board for ON/OFF triggers, antenna, power source, amoung other components. The controller can be communicatively coupled to a power source. The actuator 108 can be coupled to a linkage assembly 105 that can be coupled to an unlatching plate 101. The housing 110 can be formed as part of or coupled to a base plate 102.

A base plate 102 or base plate portion can be a direct replacement for a door’s current latch plate that is located on the side surface of the door 200. In some exemplary embodiments, a rectangular-shaped unlatching plate 101 can be positioned proximate and over at least a portion of the base plate 102, both aligned to allow for the latch 401 to extend through the corresponding apertures of the base plate 102 and latch plate 101. The base plate 102 can also have a rectangular shape or have a rectangular-shaped portion. The base plate 102 can be adapted to utilize the existing fastener hardware and any pre-existing cutouts or holes in the door 200 to easily retrofit preexisting latch plate and mounting points. In some exemplary embodiments, the base plate 102 can have a first portion that interfaces with edge surface 201 of the door. The first portion can extend past the plane of the edge surface 201. The housing 110 can be coupled to or formed onto the base plate 102. In other exemplary embodiments, the base plate 102 can include a second portion 122 that can be formed generally perpendicular to the first portion 121 and approximate the exterior surface 222 of the door. This can provide another surface to house or form the housing 110 for the drive assembly 103. The first portion 121 can additionally extend out past the plane of the door edge 201. This embodiment enables installation without requiring extensive modifications, thereby reducing the complexity and costs associated with door modification or the need for specialized tools. The various components of the present apparatus can be comprised of any suitable material, including but not limited to metal, stainless steel, hardened plastic, or aluminum alloy.

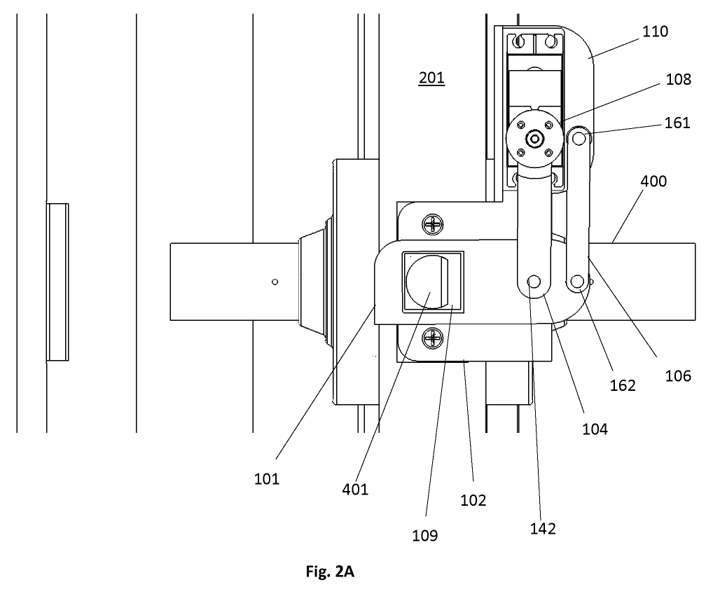

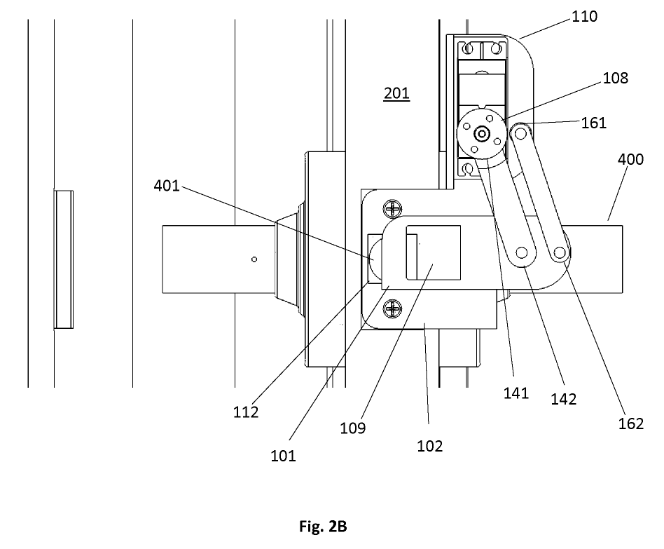

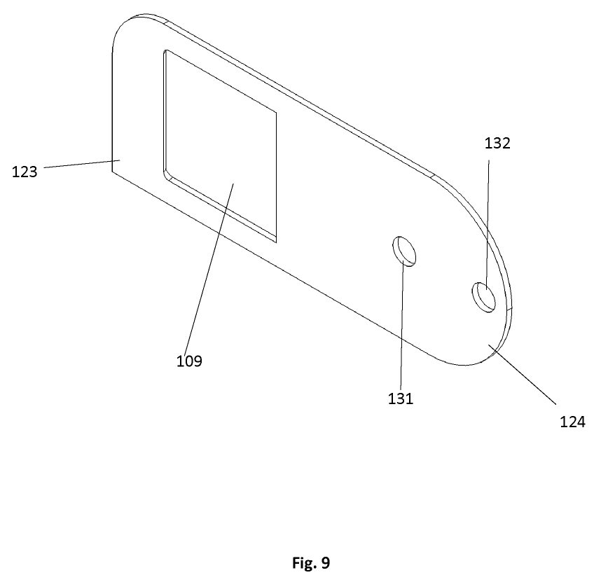

The unlatching plate 101 can have an aperture 109 and the base plate 102 or the rectangular-shaped portion of the base plate can have an aperture 112 that can correspond to an opening for the latch 401. The unlatching plate 101 can have a first end 123 and a second end 124 as shown in FIG. 9. An aperture 109 can be formed at or proximate to the first end 123 of the unlatching plate 101 and an arm 104 can be pivotably coupled proximate to the second end 124 of the unlatching plate 101. Additional coupling apertures 131,132 can be located proximate to the second end 124. The coupling apertures can correspond to the respective arms 104, 106 of the linkage assembly 105. Both apertures 109 and 112 can approximate the size of a latch 401. The aperture 109 and 112 both can have a size sufficient to receive a latch 401 through and within them. In some exemplary embodiments, the latch 401 can be spring-loaded with an angular side as shown in FIGS. 1-2. When the unlatching plate 101 is aligned to the base plate 102 or the rectangular-shaped portion of the base plate, and both are aligned to the door latch plate 300, the aperture 109 is then aligned over aperture 112 in a way that allows for the latch 401 to be positioned through the apertures 112 and 109. When latch 401 is positioned through apertures 112 and 109, an end of latch 401 can also interface with an aperture of the strike plate 501 or of the door frame or surface 500, to maintain the door 200 in a first (closed) position. The apparatus 1 is configured to move the unlatching plate 101 horizontally along the base plate 102 from a first position to a second position, when the motor is activated. During the movement into the second position, the unlatching plate 101 is capable of depressing latch 401 within an aperture of the latch plate 300 or of the door 200. The aperture 112 can be covered by an end of unlatching plate 101 thereby locking latch 401 within the aperture of the latch plate 300 or of the door 200, thereby preventing the latch 401 from engaging to the strike plate 501, and allowing the door 200 to be moved to a second (open) position (FIGS. 1-5).

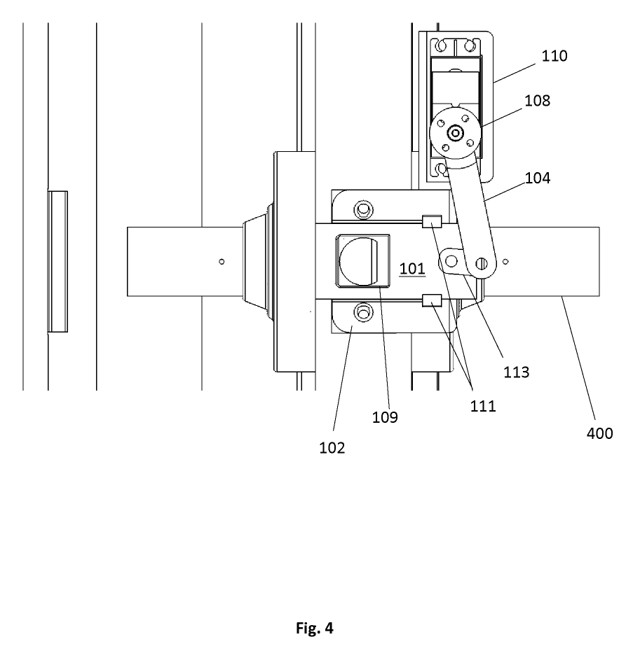

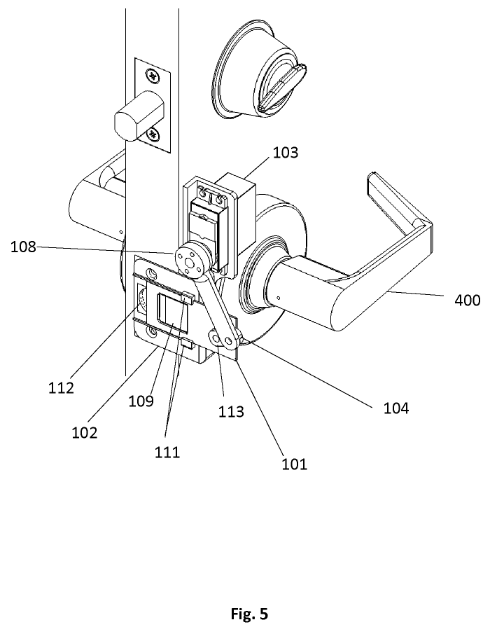

The linkage assembly 105 can generally have at least one unlatching arm 104 as shown in FIGS. 4-5 or, in some instances, can include a first arm 104 and a second arm 106 as shown in FIGS. 1-2. A first end 141 of the first arms 104 can be operatively coupled to the motor or actuator 108 and a second end 142 of the first arms 104 can be movably or pivotably coupled to the unlatching plate 101. In some exemplary embodiments, a second arm 106 can have a first end 161 and a second end 162. The first end 161 can be pivotably coupled to the housing 110 at a first point and the second end can be pivotably coupled to the unlatching plate 101 at a second point 162. The pivotable connection can be done through a fastener or other post aperture configuration to allow the arm to pivot and the connection point between the arm and unlatching plate 101. The first end of the first arm 104 can be directly coupled or linked to the actuator or motor 108 to ensure the arm moves when the motor is directed to move by the system of user. The linkage assembly 105 and drive assembly 103 are configured to drive a rotating mechanism like a conventional latch slip design, which can rotate the at least one unlatching arm, and transfer the rotation force to the unlatching plate 101 directly or via a linkage assembly 103. In some exemplary embodiments, the linkage assembly 103 can be a 4-bar mechanism to push on the latch 401 (FIGS. 1A-B). Various linkage assemblies can be utilized to accomplish the movement of the latching plate from a first position to a second position. In other exemplary embodiments a linear motor could be used to drive one or more drive arm(s) 104 to push or retract the unlatching plate 101 (FIGS. 4-5). In some exemplary embodiments a second drive arm 106 can be used to further provide a pivoting joint between a portion of the housing 110 and the unlatching plate 101. In some exemplary embodiments the drive assembly 103 can include an actuator, servo motor, or other motor 108. In some exemplary embodiments, the motor 108 can be at least partially housed within a housing 110. An arm 104 coupled between the drive assembly and the unlatching plate 101.

In some exemplary embodiments, the base plate 102 or the rectangular-shaped portion of the base plate can have at least two support arms or guide rails 111 that can provide a guide to the unlatching plate 101 along a horizontal axis along the base plate 102 to ensure the unlatching plate 101 does not tilt off (FIGS. 4-5). As also shown in FIGS. 4-5, the linkage assembly 105 can include a slider crank arm 113 coupled to the at least one arm 104 and configured to translate rotational motion from a motor 108 into linear motion to pull on the unlatching plate 101 horizontally along the base plate 102. The guide rails 111, when present, can enhance and further ensure the constant linear force on the unlatching plate 101, preventing tilting of the unlatching plate 101 during operation as well as when locked into a first or second position.

The depth of the rear wall of the strike plate 501 or the hole within the door frame to accept the latch 401 may have to be modified to ensure proper operation of an apparatus 1 of the present disclosure. It may be necessary to reduce the depth of the back wall of the strike plate or the depth of the hole in a door frame to better allow the unlatching plate to interface with an angular portion 410 of the latch 401 rather than the top flat surface 411 in order to further depress the latch 401 to open allow a door to be opened.

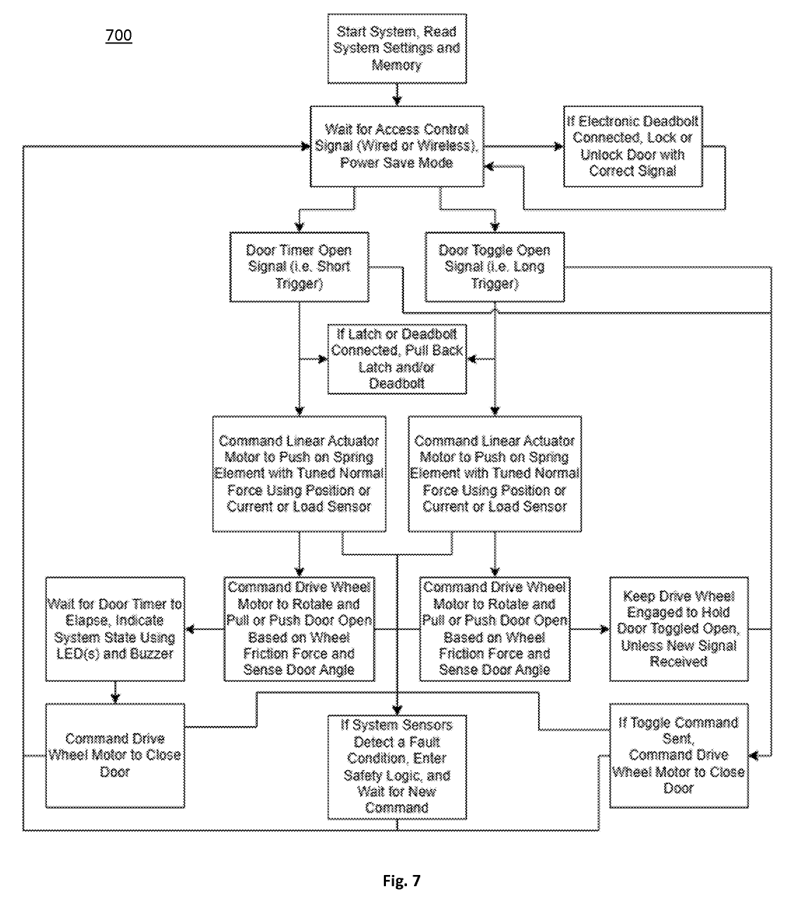

FIG. 7 provides a diagram of the operation of a door unlatching apparatus system that can be communicatively coupled with additional elements including a smart deadlock and door opening apparatus (inverted door dampers, linear, torsion, or constant force openers, electromagnet openers among others). When activated (via a button, remote control, or integrated sensor), the microcontroller signals the motor to engage. The device can be seamlessly integrated with automatic door opener systems by accepting any standard control system unlatching command, enhancing their functionality, and reducing door opener installation costs. When an automatic door opener is triggered, the unlatching mechanism activates first, ensuring the door can open smoothly and easily. A motor can drive the gearbox, which in turn moves the unlatching arm to push on the sloped part of the latch and cover the spring-loaded latch with precise force and speed such that the latch is blocked, and the door is unlatched. One or more integrated sensors monitor the position of the mechanism and latch to ensure it is fully unlatched without the actuator overextending.

The controller of the system can further be communicatively coupled to a smart deadlock system and determine the state of the door lock. The unlatching device can be configured to only unlatch the door if the door is first unlocked to save battery life and provide user interface cues to reduce user confusion. In some exemplary embodiments, the present invention can be incorporated into a smart door that can include the unlatching apparatus, a smart dead bolt, and a door opening apparatus.

In some exemplary embodiments of the door unlatching system 700 of the present disclosure, the system can first start, read, and/or access memory settings. The system can then wait for access control signal and remove itself from a powers saver mode. One or more sensors can be coupled to the system to trigger a wakeup response or initiate a control signal. An unlatching apparatus can be communicatively coupled to the system and an electronic deadbolt can similarly be optional communicatively coupled. The system can trigger and open signal to allow a user to access the door. This signal can be a programed to have one or more settings including but not limited to a short trigger setting providing a first prescribed duration for opening. Additional opening settings can be stored in the memory and configured by a user’s desired duration setting interval. The system can then initiate the drive assembly to initiate to move the unlatching member from a first position to a second position at a prescribed force for a prescribed duration. A user can provide prescribed thresholds of force to exert and one or more position or load recognition sensors that can be built into the drive assembly to determine if the unlatching plate was moved in order to unlatch the door. The system can provide a signal to maintain the unlatching plate in the second position for a prescribed time interval or duration or until an additional signal is received to move the unlatching plate back to the first position. Additionally, the system can be further communicatively coupled to a drive motor or other motor that can move the door from a first position to a second position. If any one of the sensors detect a fault or operates beyond a prescribed threshold, the system can trigger a request for a new signal or provide an alert to the user. The alert can be provided through any suitable interface including a display, speaker, or light. Upon completion of the open cycle the one or more other components can be used to move the door back to the original closed position and allow for the unlatching plate to return back to its first position.

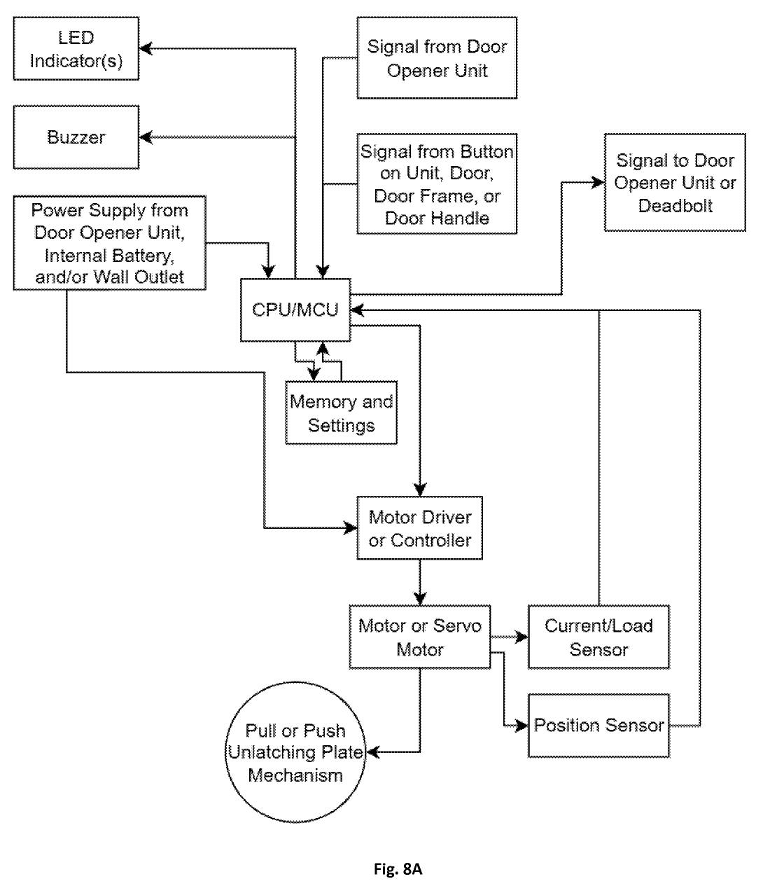

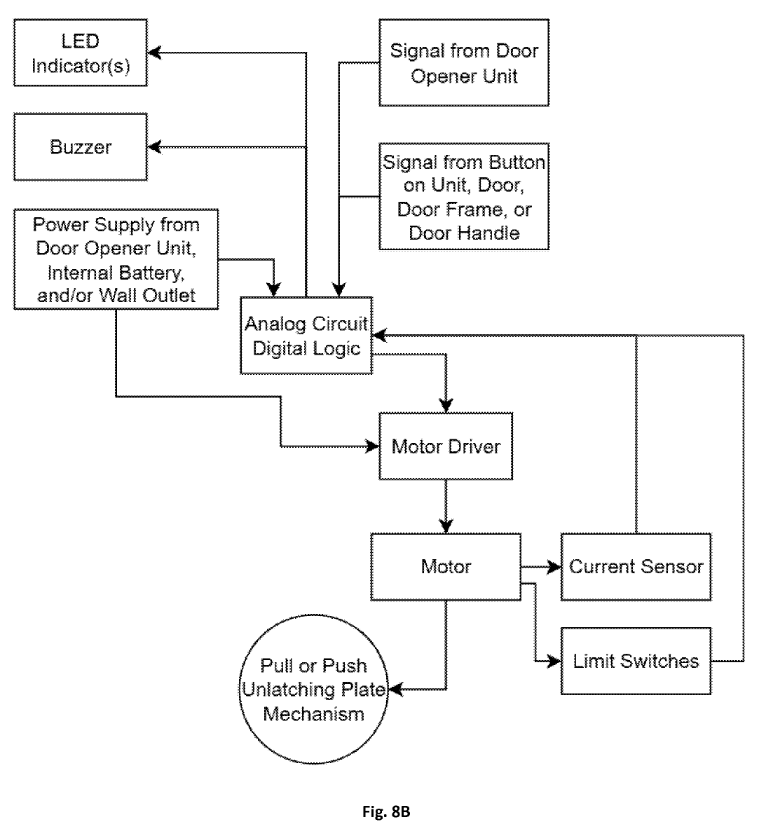

FIGS. 8A-B provide various system schematics of components that comprise the unlatching apparatus and door opening system of the present disclosure. FIG. 8A illustrates a feature-rich configuration in which a controller is communicatively coupled to a motor assembly that may include a gearbox or transmission to reduce speed and increase torque for precise, controlled movement of the unlatching plate. One or more sensors—such as load sensors, photosensors, current sensors, encoders, or limit switches—can provide feedback on latch position, engagement, and required force, enabling the controller to determine when the latch is successfully disengaged or when resistance thresholds are exceeded.

In contrast, FIG. 8B presents a simplified embodiment that can provide substantially similar unlatching functionality with a reduced set of components, while still permitting interchangeability of elements such as controller type and motor/gearbox options. Either embodiment can incorporate wired or wireless interfaces for triggers and status communication with external devices (e.g., automatic door openers or smart locks), and can include user interface elements such as buttons, LEDs, or auditory indicators to convey operational state and errors.

Various portions of various embodiments of the system can be interchanged, including but not limited to the type of controller and motors utilized. In some exemplary embodiments, the motor assembly can further include a gearbox or transmission. The gearbox can reduce the speed of the motor to increase torque allowing for precise and controlled movement of the latch plate. Additionally, the apparatus can include one or more sensors communicatively coupled to a controller and/or processing means. One or more load sensors can additionally determine the torque or force necessary to open and or move the latch plate and if there is too much resistance to unlatch the door. Additional sensors (such as a photosensor, current sensor, linear or rotational encoder, limit switches) can detect whether the latch is engaged and if the latch is successfully disengaged by the mechanism. Additional sensors can be further communicatively coupled to the system apparatus 1 of the present disclosure, including but not limited to motion sensors and IR sensors to further detect the presence of a user or person to enable a door to either automatically engage in unlatching or trigger the power source to enable the unlatching mechanism if triggered. This can be used to further preserve battery power so as to not provide power to the entire system until a user is present within a desired range or distance of the apparatus.

The controller or electronic logic circuit can process sensor data and control motor operation to provide unlatching. Additionally, the controller can be communicatively coupled to a transceiver for communicating with one or more devices through a wireless network. Additionally, the controller can be coupled to one or more user interface sensors or controls that can provide feedback and control of the system to a user.

In some exemplary embodiments, the user interface can include simple buttons or switches that can be pressed or actuated by a user. These can trigger the motor to unlatch the door or similarly relatch the unlatching plate 101. The apparatus includes an input port to receive trigger signals from external automatic door openers. When the door opener is activated, it sends a signal to the device’s microcontroller or electronic logic circuit, which then initiates the unlatching sequence so that the door opener mechanism can engage once the door is unlatched. The electronic port could also allow two-way communication between the unlatching device and the door opener system so that the door opener knows if the door opener was successfully unlatched. Further, if an automated smart lock or deadbolt is incorporated into a full door opener system, this unlatching device could engage only if it confirms that the door is unlocked first by communicating with the smart lock system.

One or more proximity sensor can be communicatively coupled to the apparatus and can detect when a person approaches the door. Once triggered by movement within its range, it automatically initiates the unlatching process without requiring manual input. Similarly, the proximity sensor could trigger the unlatching mechanism only if the system determined that the door is already unlocked via smart lock integration. Alternatively, a touch sensor on the device or door handle allows users to activate the unlatching mechanism by simply touching a designated area. This provides an alternative access method for those who prefer touch-based activation.

The apparatus can further be coupled to a display or LED light to provide visual feedback or status to a user. In some exemplary embodiments, a green LED could indicate that the device has successfully unlatched the door, a yellow LED could signal that the unlatching process has started, and a solid or blinking red LED could alert users if there is an error or malfunction. In other embodiments an auditory device, such as a buzzer could be used to provide auditory feedback to confirm actions and status. For example, a short beep could indicate that the device is powered on, or an action is initiated, continuous beeping could indicate that there is a malfunction or error, and different tones can indicate different system statuses.

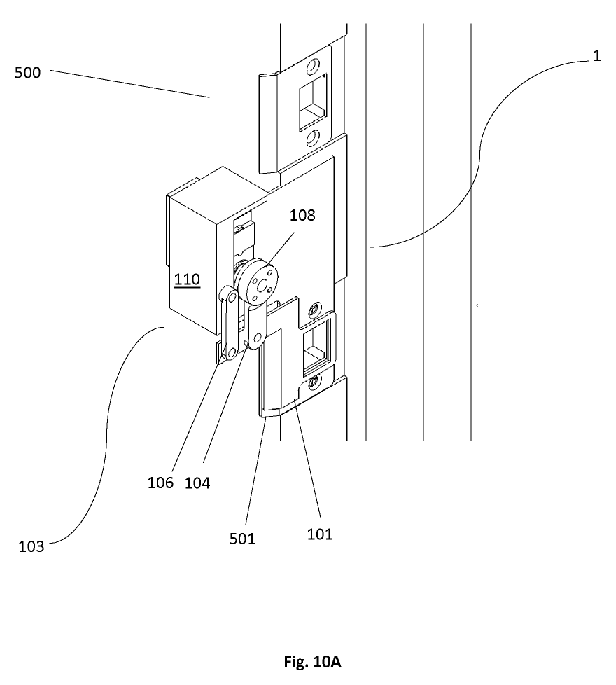

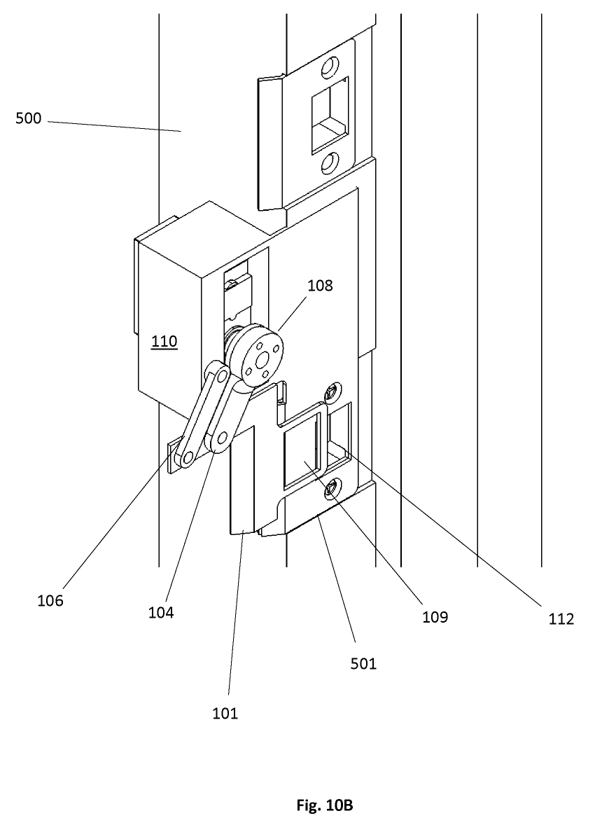

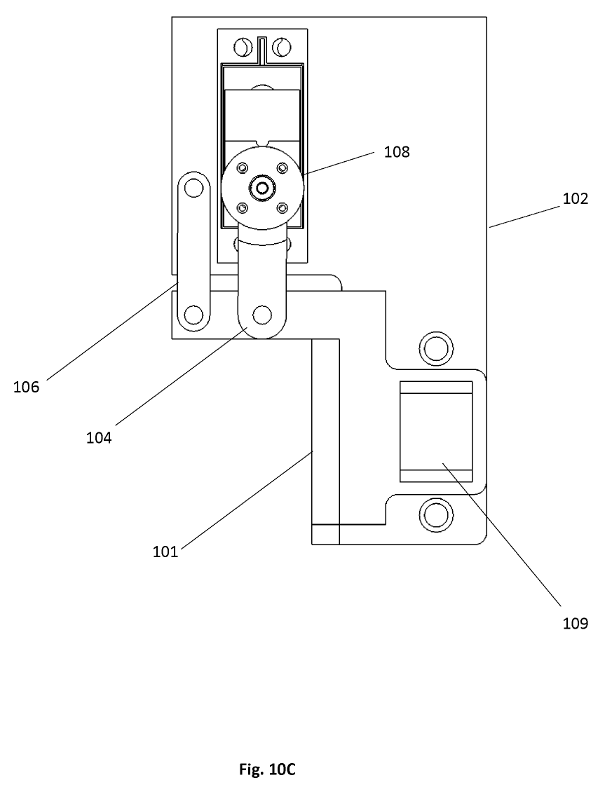

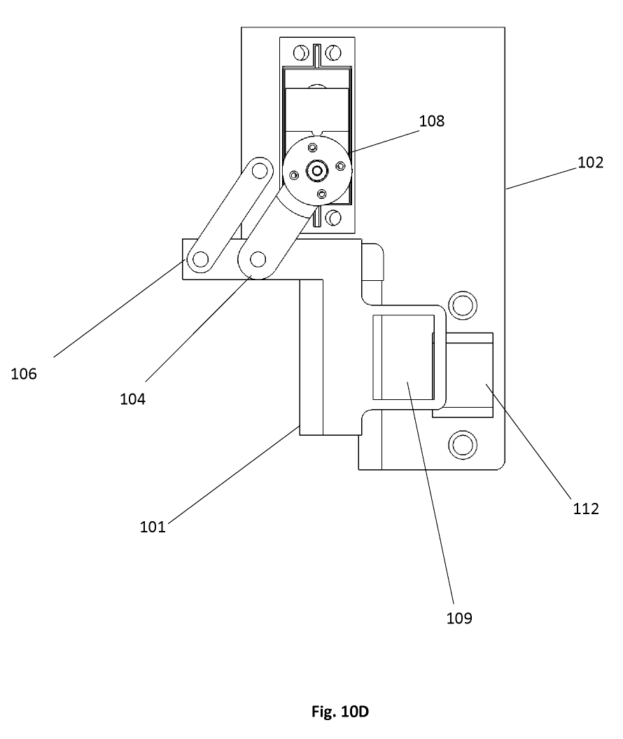

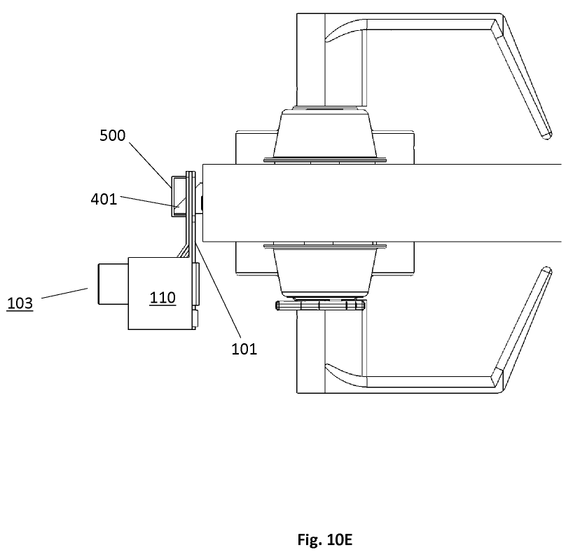

As shown in FIGS. 10A-F, the apparatus of the present disclosure can be mounted directly to the door frame 500. The apparatus 1 can include a housing 110 to house a motor assembly that can include a motor or drive. The housing 110 can additionally house other electronic components including but not limited to a controller, transceiver, or simple circuit board for on off triggers. The controller can be communicatively coupled to a power source. The motor assembly can be coupled to a linkage assembly 105 that can be coupled to an unlatching plate 101. In some exemplary embodiments, the drive or motor assembly 103 can be directly coupled to the unlatching plate 101. The housing 110 can be formed as part of or coupled to a base plate 102 which can functionally operate a strike plate as it is coupled to the door frame rather than the door. In some exemplary embodiments, the base plate 102 or base plate portion can be a direct replacement for the strike plate 501 on the door frame 500,as shown in FIGS. 10A-B, or affixed to the existing strike plate 501. In some exemplary embodiments, a U-shaped or L-shaped backwall depth plate 511 can be incorporated into the strike plate 501, or incorporated as part of the base plate 102, or as a separate device installed inside of the door frame latch receptable.

The unlatching plate 101 can have an aperture 109 and the base plate 102 can have an aperture 112 with an adjustable depth. Both apertures 109 and 112 can approximate the size of a latch 401. The aperture 109 and 112 both can have a size sufficient to receive a latch 401 through and within them. In some exemplary embodiments, the latch 401 can be spring-loaded with an angular side. When the unlatching plate 101 is aligned to the base plate 102, and both are aligned to the aperture of the strike plate 501 or of the door frame 500, the aperture 109 is then aligned over aperture 112 in a way that allows for an end of the latch 401 to be positioned through the apertures 109 and 112, and within the aperture of the strike plate 501 or of the door frame 500, to maintain the door 200 in a first (closed) position.

The apparatus 1 can be configured to move the unlatching plate 101 horizontally along the base plate 102 from a first position to a second position, when the motor is activated. During the movement into the second position, the unlatching plate 101 is capable of expelling the latch 401 from within the aperture of the strike plate 501 or of the door frame 500. An end of the unlatching plate 101 can then cover aperture 112, thereby preventing the latch 401 from engaging to the aperture of the strike plate 501 or of the door frame 500, and allowing the door 200 to be moved to a second (open) position (FIGS. 10A-F).

The linkage or drive assembly 103 can generally have at least one unlatching arm 104 or, in some instances, a second unlatching arm 106 (FIGS. 1-2). A first end of the unlatching arms 104, 106 can be operatively coupled to the motor or actuator 108 and a second end of the unlatching arms 104, 106 can be movably coupled to the unlatching plate 101. The linkage 105 and drive assembly 103 can be configured to drive a rotating mechanism like a conventional latch slip design, which would rotate one or more unlatching arms, and transfer the rotation force to the unlatching plate 101 directly or via a 4-bar mechanism to push on the latch 401. In other exemplary embodiments a linear motor could be used to drive one or more components of the linkage assembly 105 to push or retract the unlatching plate 101.

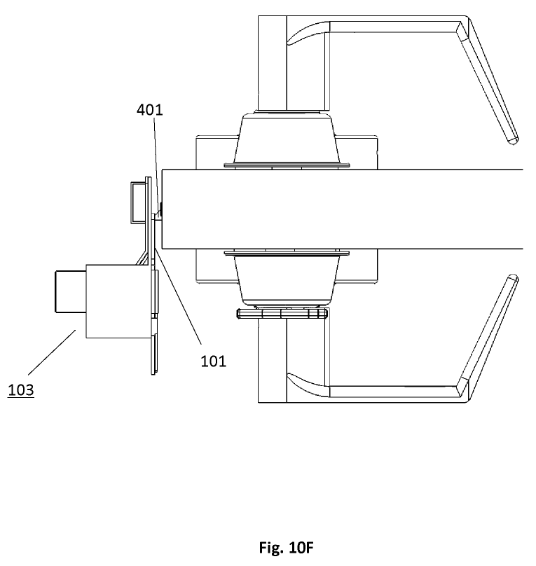

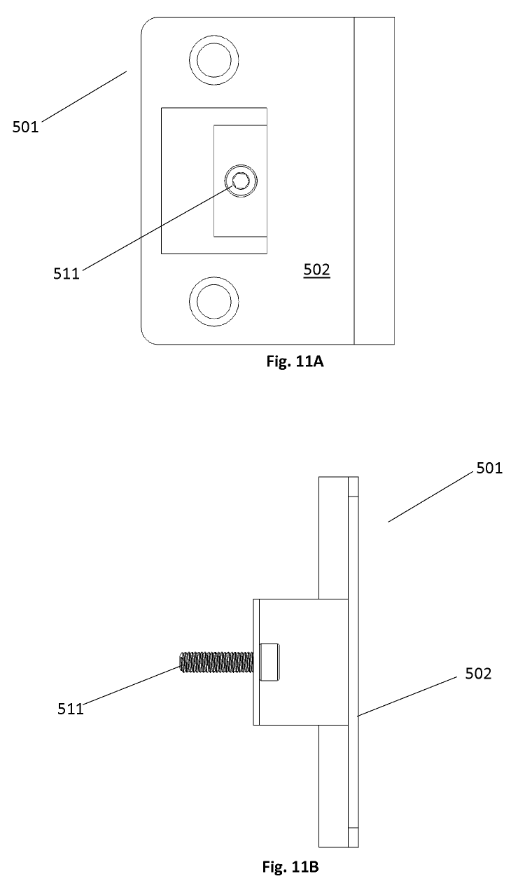

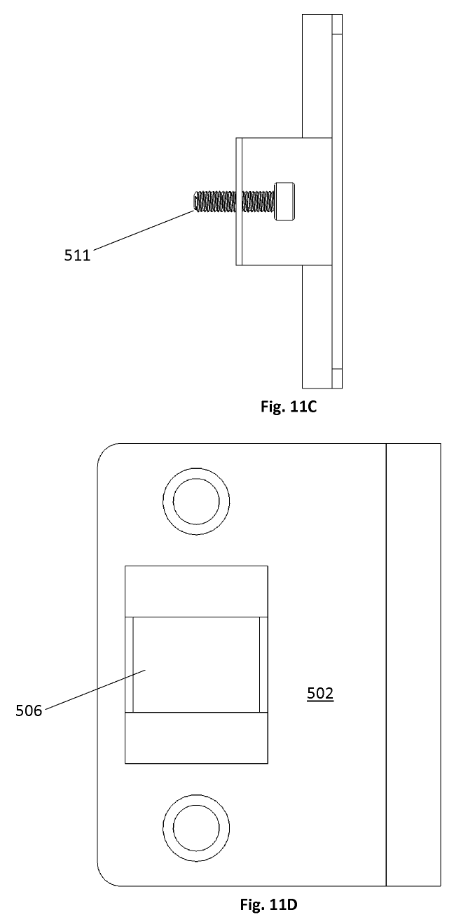

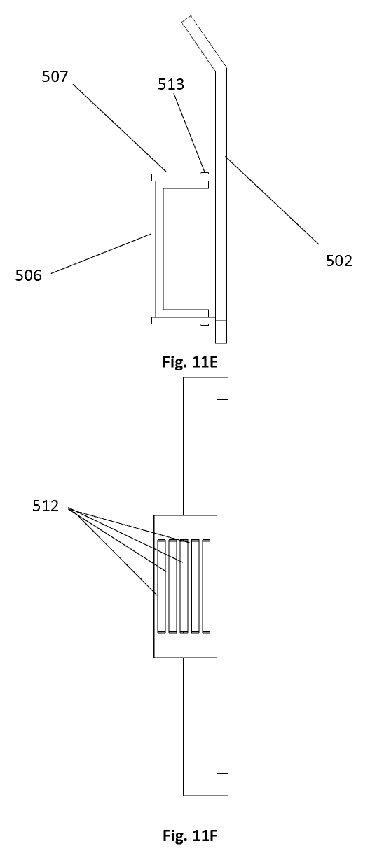

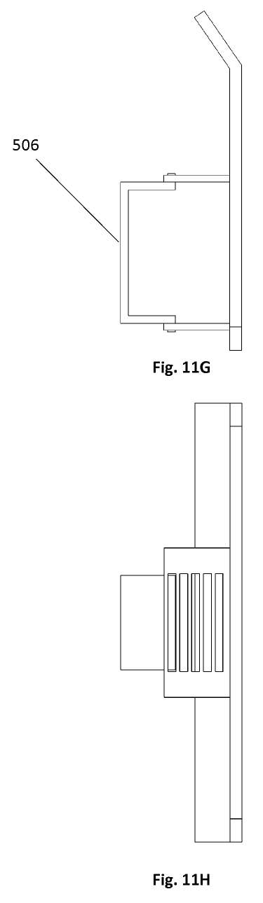

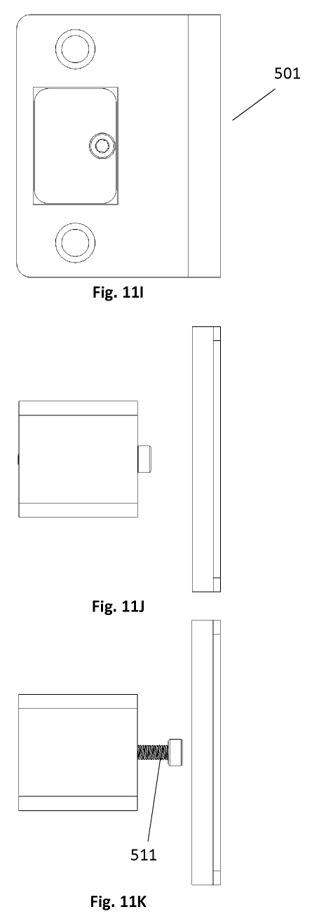

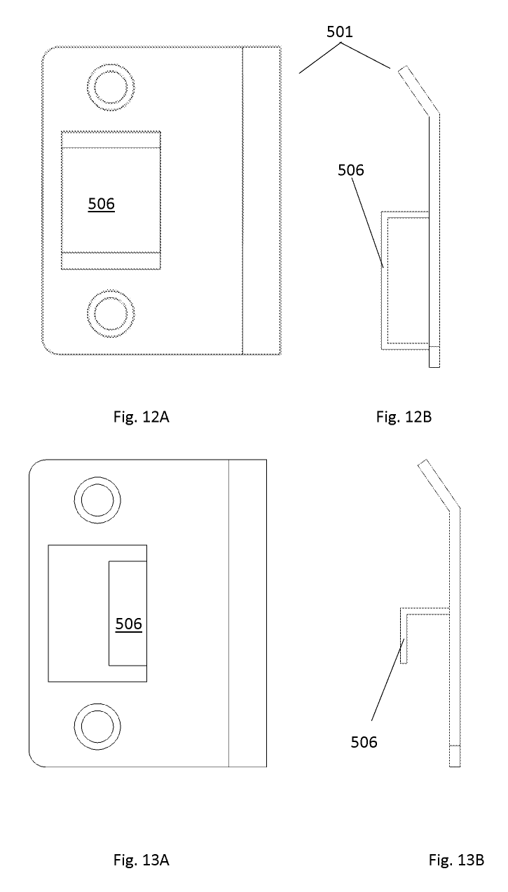

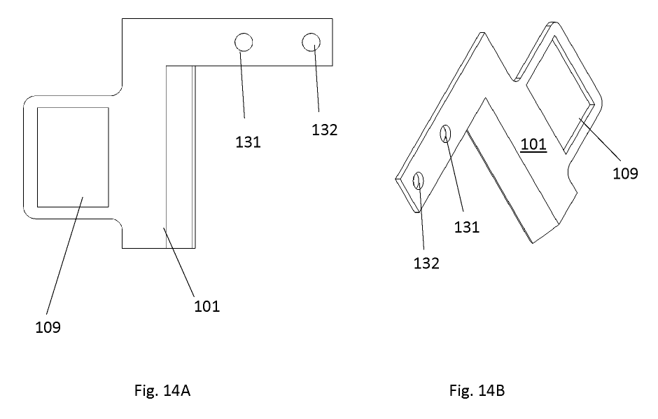

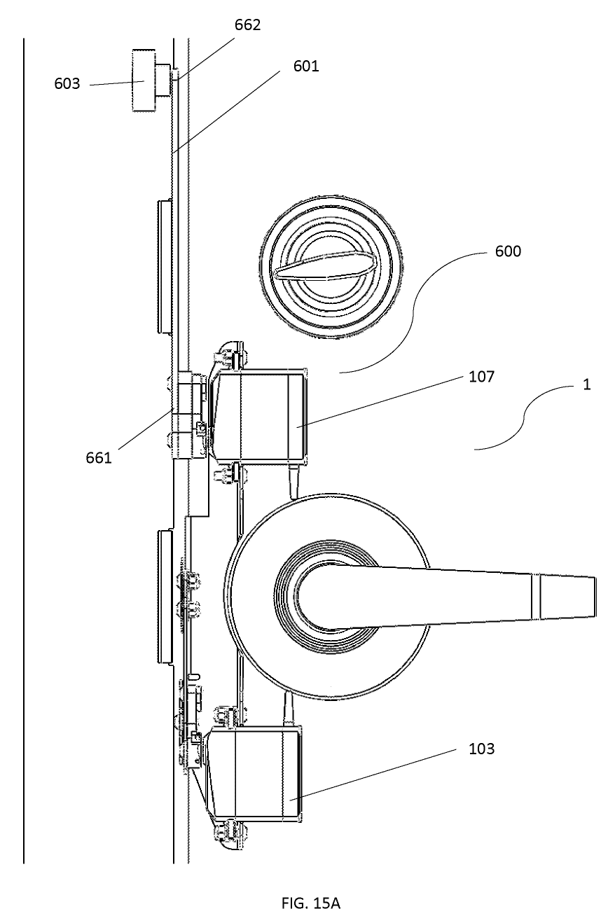

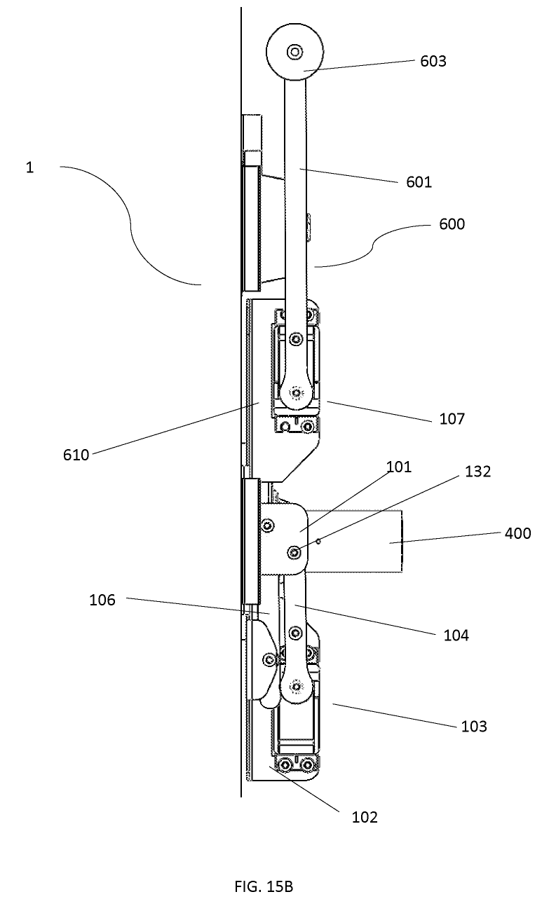

As previously recited, the depth of the strike plate for the latch 401 may need to be adjusted or changed. In some exemplary embodiments, an apparatus 1 can further comprise a strike plate 501 with an adjustment member 511, which can be comprised of metal or plastic piece that can have an adjustable portion that can use a threaded or other adjustment means to adjust the depth of the strike plate 501 as shown in FIGS. 11A-L. The adjustable depth strike plate 501 can have various different embodiments that can provide the depth adjustment member 511 to be able to easily change the depth that the latch 401 extends into the strike plate 501. As shown in FIGS. 11A-C, a strike plate 501 can include a first surface 502 and an aperture 505. Within the aperture can be a backwall 506 that can further include an adjustment member 511. In some exemplary embodiments, the adjustment member 511 can be an adjustable screw or fastener to change the depth the latch 401 can protrude into the strike plate 501. In other exemplary embodiments, a strike plate 501 can include a moveable back wall 506 that as shown in FIGS. 11D-H. In this embodiment, the strike plate can have side walls 507 that can include a one or more apertures 512 to interface with the moveable backwall portion 506. The back wall portion can include one or more interlocking portions 513 that interface with the apertures to allow the depth of the backwall 506 from the surface of the strike plate 501. The adjustment member 511 can be installed into the door frame 500 latch receptacle cutout as shown in FIGS. 11I-K or attached to the strike plate 501 as shown in FIGS. 11A-C. The strike plate 501 can be adapted to utilize the existing screw hardware and any pre-existing cutouts or holes in the door frame 500. This embodiment enables installation without requiring extensive modifications, thereby reducing the complexity and costs associated with door modification or the need for specialized tools. Other embodiments of strike plates are shown in FIGS. 12-13 providing different embodiments that can have fixed depth backwall. FIGS. 14A-B provide illustrations of an exemplary embodiment of an unlatching plate 101 having a first aperture 109. It should be understood that these embodiments can be modified to be adjustable similar to the other embodiments.

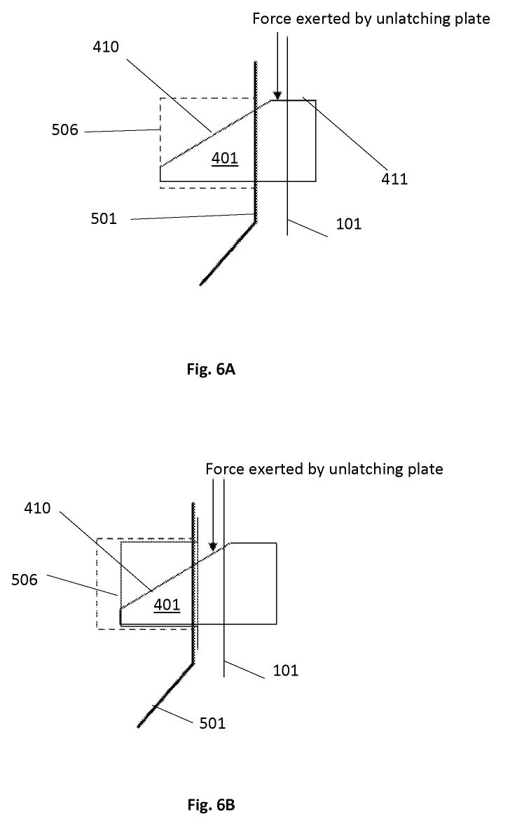

Some latches 401 have a flat spot at the bottom near the door with no angle before they slope towards the tip. To compensate for this, the depth plate 511 can attach to the strike plate 501 in the door frame that controls the depth of the spring-loaded latch 401 insertion into the door frame 500. This can reduce the spring-loaded latch depth inside of the door frame 500 to eliminate the sharp slope or right-angled flat edge so that the door 200 can be easily unlatched while still allowing the door to latch close. The depth plate 511 can be configured to reduce the depth that a spring-loaded latch bolt 511 extends into the strike plate 501. This adapter depth plate 511 may only be required for doors that utilize a longer latch 401 that has a flat edge portion that extends from the end of the face/latch plate as shown in FIG. 6.

In some exemplary embodiments, a linkage or transfer assembly 105 can be a 4-bar linkage that can be on a typical door. A button can be pressed communicatively coupled to the motor assembly electronics that can activate the movement of the motor. The motor 108 can then drive the linkage assembly 105 to move the unlatching plate 101 or the latch popper assembly 600. Pressing the button or triggering the device can unlatch the door by blocking the latch 401 for about 5-10 seconds before it releases the latch 401 in some exemplary embodiments. The time interval can be customized and set to the users desired interval. The apparatus can be fully compatible with most standard door handles assemblies 410 that have a standard strike 501 or latch plate 300 for the home. Additionally, the apparatus 1 can also be compatible with different handle and strike or latch plate standards, such as those found in commercial settings. The assembly can be communicatively coupled to a power source. The power source can be any suitable type, including, but not limited to a direct wired to a house outlet or circuit, battery powered, powered by an automatic door opener unit, or solar powered.

The motor assembly can include any type of suitable motor. A motor (a servo motor, could also be a DC, stepper, brushless, or AC motor) that drives the unlatching arms or latch popper assembly, ensuring it has enough force to push on the sloped side of the spring-loaded latch and unlatch the door. The rotary sliding elements could include ball bearings, plain bushings, and self-lubricating bushing for the joints. The linear sliding elements could include low friction surfaces like PTFE/Teflon or other slippery plastics or use lubricant.

The drive assembly 103 can include a bar linkage assembly that can have one or more linkage arms. A 2/4-bar linkage (parallel mechanism) or slider crank arm 113 mechanism in a slot or guide 111 can be configured to translate rotational motion from an actuator into linear motion to pull on the unlatching plate 101. Alternatively, the mechanism could be a rotating actuation arm like a conventional latch slip design, which would rotate the unlatching plate 101 directly or via a 4-bar mechanism to push on the latch. In other exemplary embodiments a linear motor could be used to drive an arm to push or retract the unlatching plate 101. Similarly, on the door frame embodiment, a motor assembly similarly drives the unlatching plate 101.

The unlatching plate 101 can be comprised of any suitable material and can have any suitable thickness to allow it to slide in between the strike plate 501 and the base plate 102 or latch plate 300. When the motor is actuated, the drive or linkage assembly 105 can push or pull the unlatching plate 101 against the sloped side of the spring-loaded latch 401 on the door 200 such that it is pushed back out of the door frame latch hole receptable past the strike plate 501 and back into the door 200 so the door can freely open. The drive motor can move the unlatching plate 101 between a first position and a second position. The unlatching plate 101 can have an aperture that can approximate the size of a latch. In some exemplary embodiments, the latch can be spring-loaded with an angular side as shown in FIGS. 1-2. The latch can be positioned through the aperture when the unlatching plate 101is in the first position and the end of the latch can interface with the strike plate 501 to maintain the door in a first (closed) position. When the motor is activated and the unlatching plate 101 is moved to the second position, the latch can be depressed and covered thereby preventing it from engaging the strike plate and allowing the door to be moved to a second (open) position.

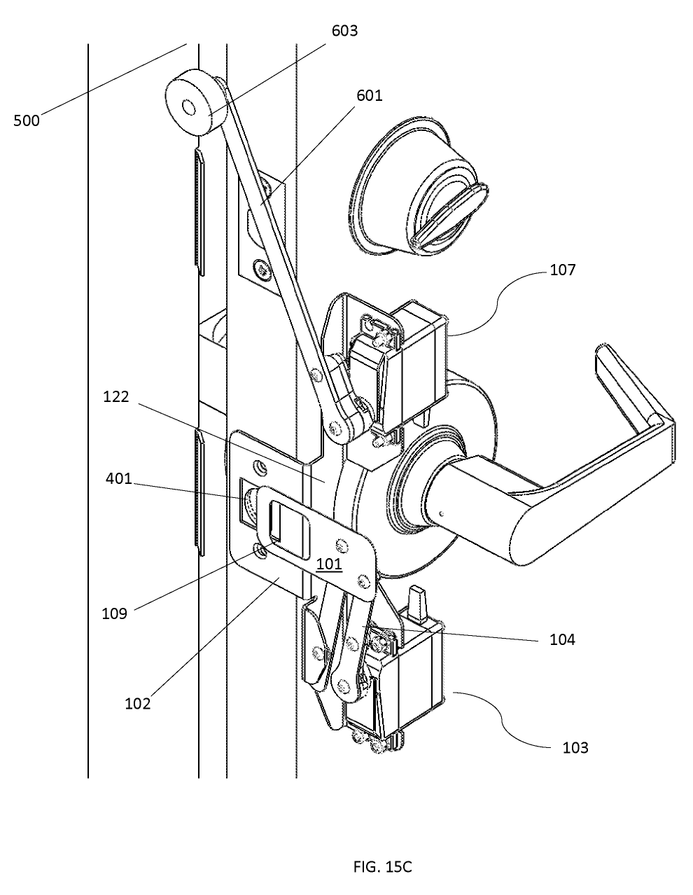

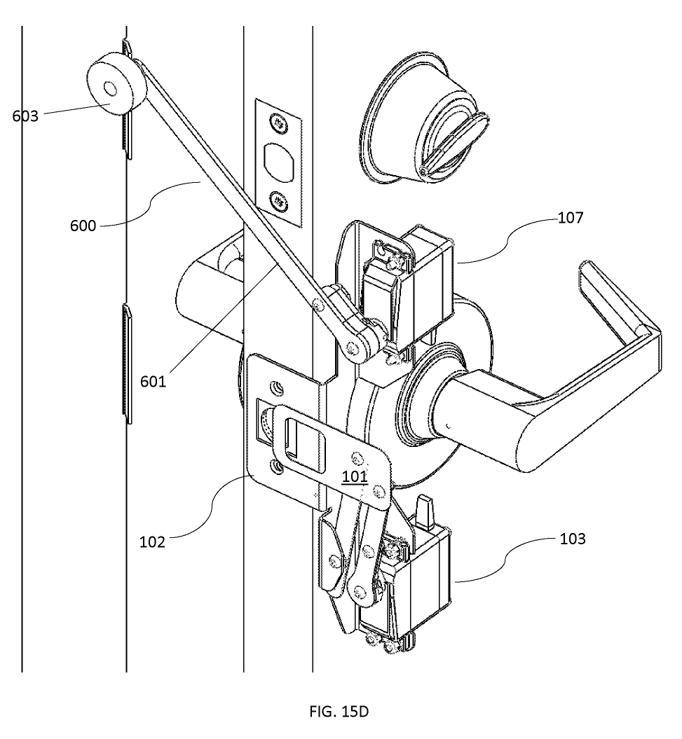

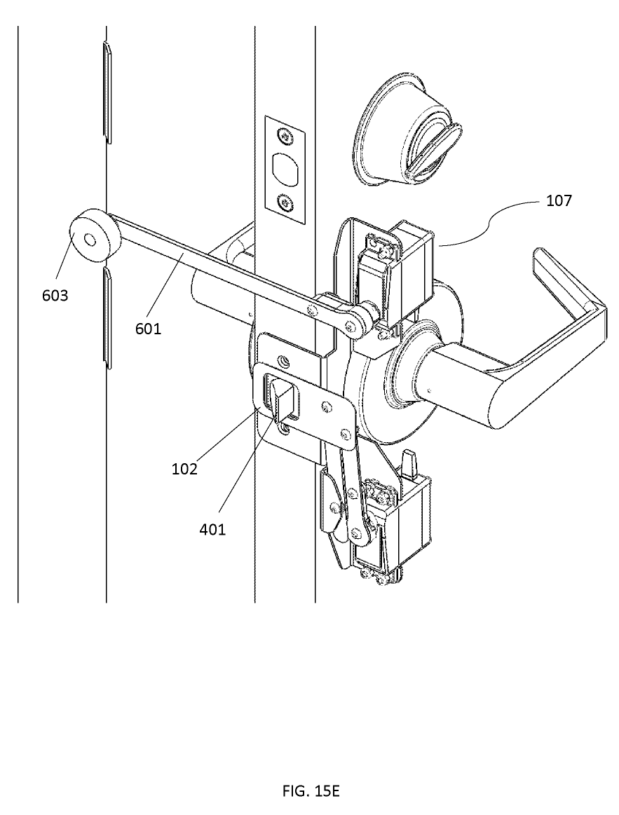

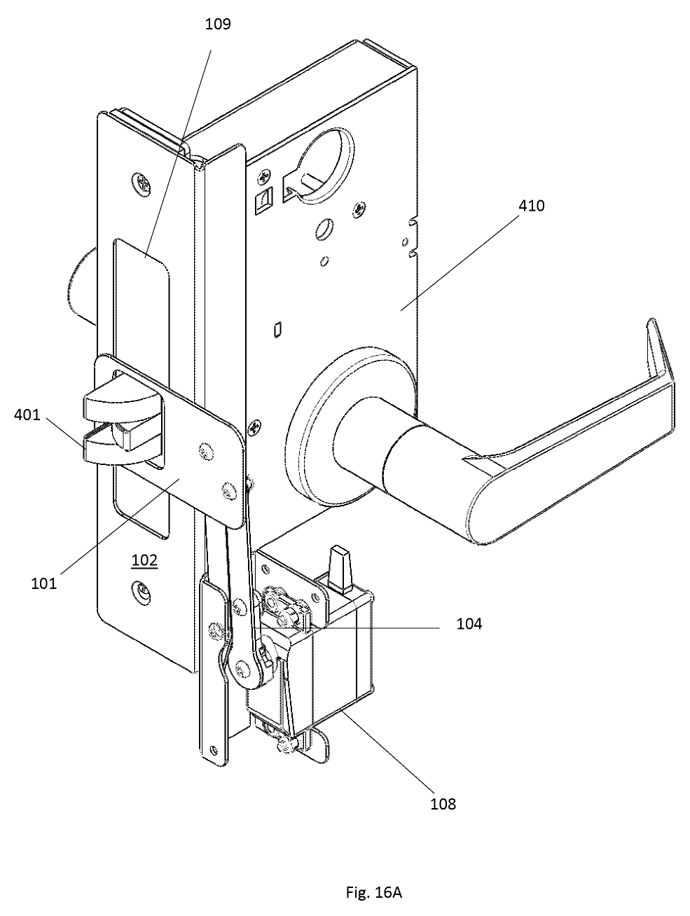

As shown in FIGS. 15A-E, to enhance independent accessibility, the apparatus 3 may further include a latch popper assembly 600. The latch popper assembly can include a housing 610. The latch popper assembly 600 can be mounted directly to door 200 or latch plate 102 or adjacent wall. Alternatively, the latch popper assembly 600 can be coupled to base portion 102 or to housing 110. The latch popper assembly 600 can share the existing unlatching motor assembly 103 or can have an independent motor assembly 107. The latch popper assembly 600 can comprise an actuator-driven arm 601 - such as a lever, linkage, or telescoping member – having an extendable length and configured to extend an adjustable distance from and between a first position and a second position with multiple positions in between. The arm 601 can have a first end 661 and a second end 662. A wheel or rotatable member 603 can be pivotably coupled to a second end of the arm 601 to interface with a surface 500 such as a door frame or adjacent wall to provide a force against the surface in order to prop open the door. FIGS. 15C-E illustrate the operation of the popper assembly moving the arm between multiple positions against a surface in order to open the door after the latch has been unlatched by the drive assembly 103. It should be understood that a more complex linkage assembly 105 could be utilized to allow for a single drive assembly to drive both the unlatching plate 101 and the popper arm 601. In some exemplary embodiments, the second portion 122 of the base plate can extend along the plane of the door and providing a mounting surface for the popper assembly 600 and the drive assembly 103 as shown in FIG. 15C.

The latch popper assembly 600 can extend from the initial door (first position) to the door frame (second position). Upon successful retraction of the latch, when the unlatching plate 101 depresses latch 401 into the latch plate 300, the latch popper assembly 600 is energized to physically move the door 200 from a closed position (latch popper assembly 600 in the first position) to an ajar or partially open position (latch popper assembly 600 in the second position). A grip member 603 located at an end of the latch popper assembly 600 touches a portion of the door frame 500 when in the second position, exerting a controlled force against the door frame 500 or adjacent wall. In a preferred embodiment, the latch popper assembly 600 comprises a low-friction sliding or rolling interface, such as a polymeric idler wheel 603, to ensure smooth extension and prevent marring of the door frame.

The length extension of the latch popper assembly 600 adds momentum to the door opening cycle by torquing the latch popper assembly 600 against the door frame 500. The latch popper assembly 600 is capable of applying force to the door frame 500 and facilitate the door to move from the ajar position (latch popper assembly 600 in the second position) to an open position, when the latch popper assembly 600 moves from the second position to the third position. The grip member 603 can be a rubber or plastic idler wheel configured to roll along the door frame 500 or adjacent wall. The latch popper assembly 600 could also push directly against the door frame 500 or adjacent wall with a 4-bar, scissor, or more complex linkage assembly to accomplish the same function. In some exemplary embodiments, a door opening mechanism can further be coupled to the door to further move the door from a closed to open position after the latch popper provides its initial movement of the doors. Similarly, a door opening mechanism can function simultaneously with the latch popper assembly 600 to more easily open the door.

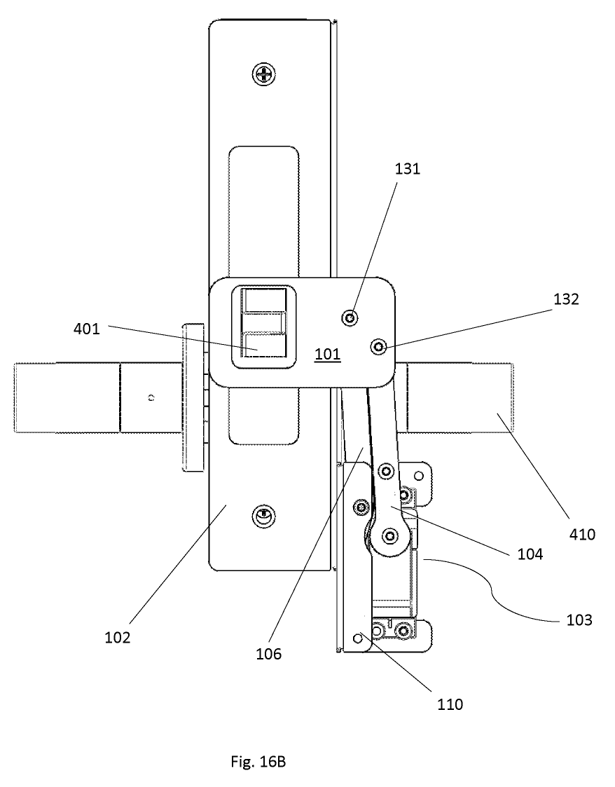

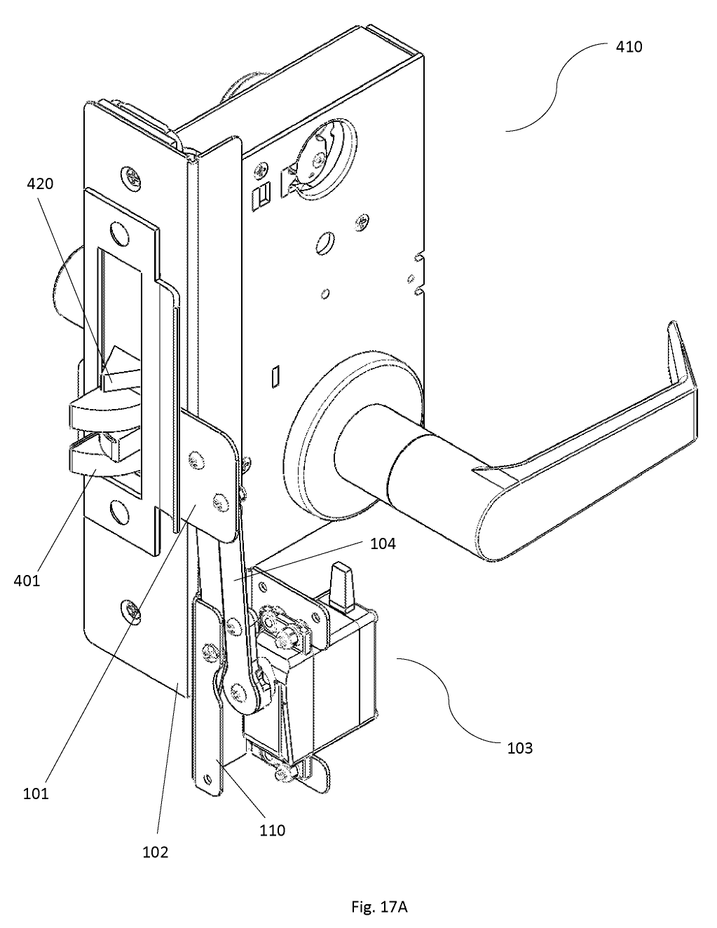

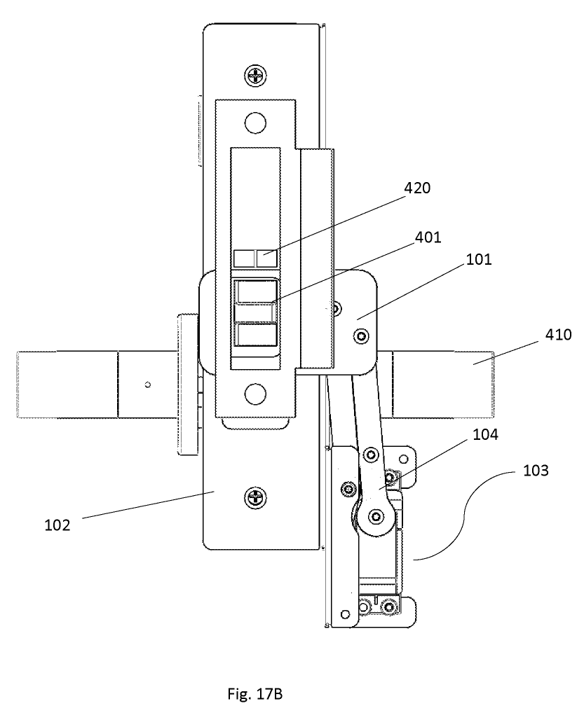

FIGS. 16-17 provide illustrations of exemplary embodiments of an unlatching apparatus of the present disclosure that can be used with deadlatch enabled latches. FIGS. 16A-B provide for a unlatching apparatus that can be adapted to be used with mortise-lock systems in the marketplace. These provide similar components where the base plate 102 can be utilize to provide for accounting for the deadlatch component 420 to disable the deadlatch feature of the latch 401. The base plate 102 can similarly be used to provide a mounting location or form a housing for a motor assembly 103. In other embodiments, the housing 110 or motor assembly 103 can be directly mounted to the outer surface of the door 400.

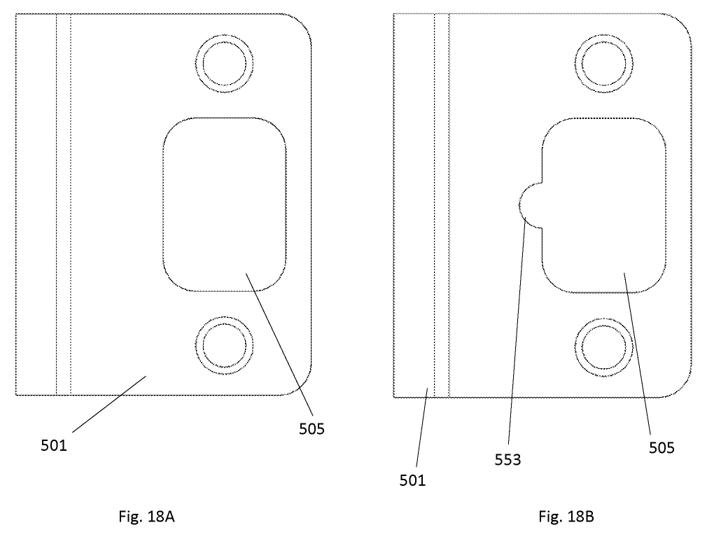

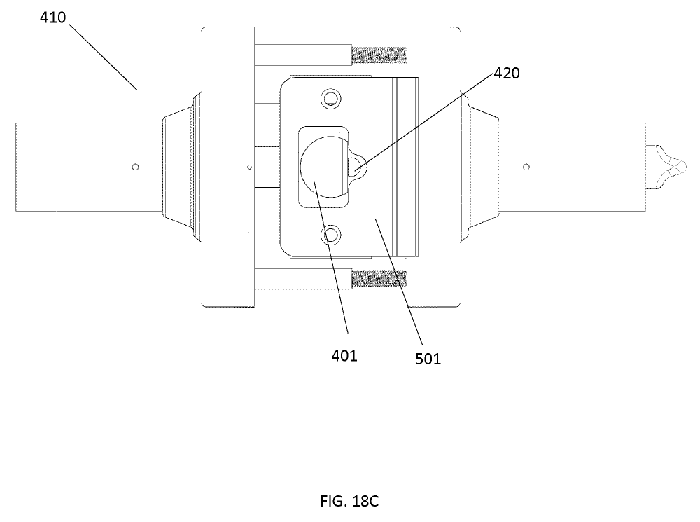

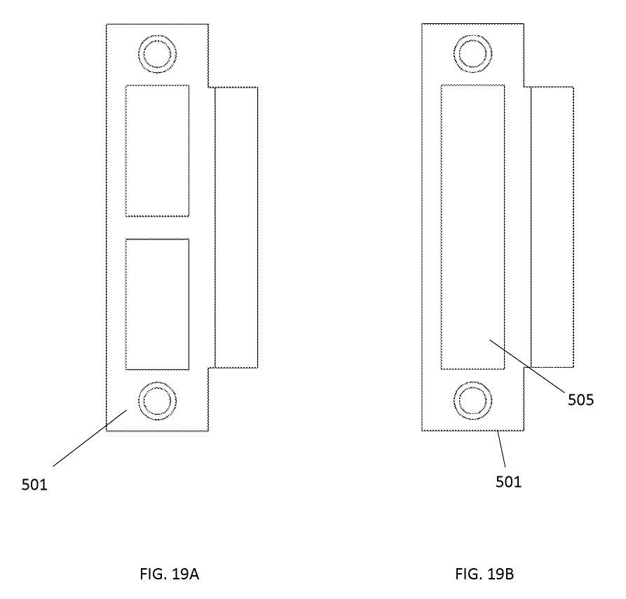

FIGS. 18A provides a traditional strike plate 501 for a typical household locking having a deadlatch. FIG. 18B provides a modified strike plate with an indention 553 to prevent contact with the deadlatch to disable the traditional deadlatch that further increases operation efficiency of an apparatus of the present disclosure. FIG. 18C provides an illustration of a side view of a door handle latch assembly 410 with the modified strike plate to allow for the deadlatch to be disabled. Similarly, FIG. 19A provides a traditional example of a mortise mount commercial strike plate for a deadlatch embodiment. FIG. 19B provides a modified strike plate 501 there by disabling the deadlatch for an exemplary embodiment of an apparatus of the present disclosure. To further enhance or facilitate unlatching in these configurations, a modified strike plate 501 can be provided. This strike plate 501 includes a relief or cutout geometry specifically positioned to coincide with the deadlatch bolt. By providing a void that prevents the deadlatch from being depressed against the strike plate surface, the deadlatch remains in a disengaged state, thereby permitting the primary spring-loaded latch to be retracted by the unlatching plate of the current invention.

In another exemplary embodiment, a non-destructive deadlatch disabling insert can be provided to enable compatibility with high-security tubular or mortise-mounted handles. This insert can comprise one or more shim members configured to be seated within the existing aperture of a standard strike plate. The insert is geometry-specific to create a localized 'relief pocket' or stop that prevents the deadlatch pin from being depressed against the door frame when the door is in a closed position. By maintaining the deadlatch pin in an extended state, the primary spring-loaded latch remains retractable by the unlatching plate. This embodiment facilitates the automation of secured exterior or commercial doors without requiring the removal or modification of original, potentially fire-rated, or UL-certified, door hardware.

The present disclosure provides an alternative to traditional apparatus that require a large cost and additional space compliance. The apparatus can function as an option to equip doors to be easily pushed open, and large easy-to-grasp pull handles, straps, or foot handles could be added to make it easier to pull the unlatched door open.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

The system may interact with other devices and networks to communicate with the client(s). Hardware may include video cameras, microphones, video players, cameras, and accessing other apps or software for communicating and transferring data to update the display output. The output may then be modified with hardware data capture information. Such as using the camera to capture video and displaying the video in real-time on the output display, including audio played over speakers.

Other networks may be in communication with the system, such as a network of service providers and information related to providing services. Other networks and other applications, such as accessing a calendar to determine availability and scheduling the service appointment. Navigation may be accessed to help with directions to where the service is to be provided.

The user may provide an interface to other devices including, without limitation, servers, other clients, printers, database servers, print servers, file servers, communication servers, distributed servers, and the like. Additionally, this coupling and/or connection may facilitate remote execution of one or more programs across a network. The networking of some or all of these devices may facilitate parallel processing of a program or method at one or more locations. In addition, any of the devices attached to the client through an interface may include at least one storage medium capable of storing methods, programs, applications, code, and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other network types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

What is claimed is:

1. A door unlatching apparatus, comprising:
a base plate configured to couple to a door or a door frame;
an unlatching plate configured to interface against the base plate, wherein the unlatching plate has a first aperture configured to approximate a shape of a spring-loaded latch of a door knob assembly;
a linkage assembly having a first end and a second end, wherein the first end is configured to couple to a portion of the unlatching plate;
a motor assembly configured to couple to a surface of the door or door frame, wherein the motor assembly is coupled to a second end of the linkage assembly, wherein the linkage assembly has one or more arms configured to translate rotational motion from the motor to move the unlatching plate between a first position that allows the latch to spring into the latch receptacle aperture and a second position where the latch is pushed back into the door and depresses the latch.

2. The door unlatching apparatus of claim 1, further comprising an electronic logic circuitry coupled with said motor assembly, said linkage assembly, and said unlatching plate, configured to control the sequence of operations based on an input trigger.

3. The apparatus of claim 2, wherein the base plate is mounted directly onto existing hardware of a door or door frame using the existing screws typically used to secure the door's latch plate or door frame’s strike plate.

4. The apparatus of claim 3, wherein the base plate has a first portion and a second portion, wherein the motor assembly is coupled to a second portion of the base plate.

5. The apparatus of claim 4, wherein the motor assembly includes a housing and the linkage assembly further comprises a second arm having a first end and a second end, wherein the first end is pivotably coupled to the housing of the motor assembly and the second end is pivotably coupled to the unlatching plate.

6. The apparatus of claim 5, further comprising a strike plate with an adjustable member, wherein the strike plate is installed inside of a door frame latch receptacle and adjusted to set the latch depth in strike plate for the latch.

7. The apparatus of claim 6, further comprising a controller programmed to process sensor data and control motor operation for precise and controlled movement of the unlatching plate.

8. The apparatus of claim 7, further comprising a user interface including buttons for manual actuation, LEDs for visual feedback indicating the status of the unlatching process, and an auditory feedback system emitting tones to confirm actions or indicate malfunctions.

9. The apparatus of claim 8, wherein said electronic logic circuitry is configured to receive or send signals from external automatic door openers through one or more electronic ports.

10. The apparatus of claim 9, further comprising a power source selected from the group consisting of direct wired connections to a house outlet or circuit, battery-powered units, automatic door opener system units, or solar-powered units.

11. The apparatus of claim 10, further comprising a transceiver configured to communicate with one or more external devices through a wireless network.

12. The apparatus of claim 11, further comprising an input port enabling communication between the unlatching device and an automatic door opener system or automatic deadbolt for smart door system integration.

13. The apparatus of claim 12, further comprising a smart lock or deadbolt system communicatively coupled to the controller, wherein said system is configured to confirm whether the door is unlocked before initiating the unlatching process.

14. The apparatus of claim 13, further comprising a proximity sensor detecting when a person approaches the door, automatically triggering the unlatching process without manual input.

15. The apparatus of claim 14, further comprising a touch sensor on the device or door handle enabling users to activate the unlatching mechanism by touching a designated area.

16. The apparatus of claim 15, further comprising a latch popper assembly mounted directly to the door or latch plate or adjacent wall and having an extendable length configured to extend an adjustable distance from a first position, to at least a second position and a third position.

17. The apparatus of claim 16, further comprising a grip member located at an end of the latch popper assembly, the grip member configured to touch a surface adjacent to the door when in the second position, exerting a controlled force against the door frame or adjacent wall.

18. A door unlatching apparatus, comprising:
a base plate configured to be mounted to an edge surface of a door, wherein the base plate has a first aperture configured to receive a spring-loaded latch of a door knob therethrough;
an unlatching plate positioned over at least a portion of the base plate, the unlatching plate having a second aperture configured to align with the first aperture to permit the spring-loaded latch to extend therethrough when the unlatching plate is in a first position;
a motor assembly coupled to the base plate; and
a linkage assembly having a first end operatively coupled to the motor assembly and a second end coupled to the unlatching plate, wherein the linkage assembly is configured to translate motion from the motor assembly to move the unlatching plate from the first position to a second position;
wherein, when the unlatching plate is moved to the second position, the unlatching plate engages a sloped portion of the spring-loaded latch to depress the latch and covers the first aperture to prevent the latch from re-engaging a strike plate, thereby permitting the door to be opened.

19. A smart door system, comprising:
a door unlatching apparatus comprising:
a base plate configured to be mounted to a door or door frame;
an unlatching plate having an aperture configured to receive a spring-loaded latch therethrough in a first position;
a motor assembly configured to move the unlatching plate from the first position to a second position to depress and cover the spring-loaded latch; and
a controller communicatively coupled to the motor assembly; and
a smart deadbolt communicatively coupled to the controller, wherein the controller is configured to determine a state of the smart deadbolt, wherein the controller is configured to initiate an unlatching sequence only upon confirmation that the smart deadbolt is in an unlocked state.

20. The system of claim 19, further comprising an automatic door opener communicatively coupled to the controller, wherein the controller is configured to receive a trigger signal from the automatic door opener to initiate the unlatching sequence.
